(19) United States
(12) Patent Application Publication
(10) Pub. No.: US 2026/0323161 A1
(43) Pub. Date: Oct. 15, 2026

(54) Image-Denoising Preprocess for Robust Contrast-Detection Autofocus with Low-Light and Low-Contrast Subjects

(71) Applicant: Google LLC, Mountain View, CA (US)

(72) Inventors: Mark Gamadia, Los Gatos, CA (US); Jae Soo Kim, San Diego, CA (US)

(73) Assignee: Google LLC, Mountain View, CA (US)

(21) Appl. No.: 18/880,636

(22) PCT Filed: Oct. 3, 2023
(86) PCT No.: PCT/US2023/075813

§ 371 Date: Jan. 2, 2025

(51) Int. Cl. H04N 23/67; G06T 5/20; G06T 5/70; H04N 23/63

(52) U.S. Cl. CPC H04N 23/675; G06T 5/20; G06T 5/70; H04N 23/632

(57) ABSTRACT

The present document describes techniques for an image-denoising preprocess for robust contrast-detection autofocus with low-light and low-contrast subjects. The techniques described herein provide a software preprocessing approach for denoising image data for contrast-detection autofocus, particularly with low-light conditions and low-contrast subjects. This software autofocus technique utilizes a Gaussian pyramid to reduce noise and downscale the image to reduce computation costs. In aspects, a spatially adaptive denoise preprocessing technique (e.g., Wiener filter, bilateral filter) is then applied to further reduce noise prior to contrast-detection autofocus measurement generation. The denoise preprocessing technique provides a denoised output that is used as input to a focus-value filter for multizone focus-value measurements usable for focusing a camera.

### BACKGROUND

Users generally expect an autofocus system of a mobile camera system to function under all conditions, including low-light conditions and/or low-texture subjects, which are difficult conditions for conventional autofocus systems to consistently capture a sharp image or video. This difficulty is due to conventional hardware (HW) contrast-detection autofocus (CDAF) systems being easily influenced by noise in low-light and low-texture scenes. Consequently, many local false peaks in the HW signal are generated in contrast measurements, making it challenging for the camera's autofocus system to perform its function of locating a focused peak in the HW signal.

Many cases exist where a hybrid autofocus system relies on contrast autofocus measurements to help determine the final “best” lens position for image capture. One example includes a fine scan following a phase-detect-autofocus process. Another example includes an autofocus system completely driven by contrast autofocus in the absence of a high-confidence phase-detect-autofocus estimate or a reliable active-depth (e.g., time-of-flight) estimate. However, such conventional autofocus systems continue to perform poorly in low light and/or for low-texture subjects, resulting in a low-quality image and a poor user experience.

### SUMMARY

The present document describes techniques for an image-denoising preprocess for robust contrast-detection autofocus with low-light and low-contrast subjects. The techniques described herein provide a software preprocessing approach for denoising image data for contrast-detection autofocus, particularly with low-light conditions and low-contrast subjects. This software autofocus technique utilizes a Gaussian pyramid to reduce noise and downscale the image to reduce computation costs. In aspects, a spatially adaptive denoise preprocessing technique (e.g., Wiener filter, bilateral filter) is then applied to further reduce noise prior to contrast-detection autofocus measurement generation. The denoise preprocessing technique provides a denoised output that is used as input to a focus-value filter for multizone focus-value measurements usable for focusing a camera.

In aspects, a method for an image-denoising preprocess for robust contrast-detection autofocus with low-light conditions and low-contrast subjects is disclosed. The method includes receiving image data for a contrast-detection autofocus operation by a digital camera, applying a Gaussian pyramid blur to the image data to provide blurred-image data, executing a denoising preprocess on the blurred-image data to provide noise-reduced image data, filtering the noise-reduced image data using a focus-value filter to provide a filtered output, and extracting a focus value from the filtered output to use in the contrast-detection autofocus operation for focusing the digital camera. The method may be a computer implemented method. The method may further comprise capturing, by a digital camera, image data.

In further aspects, a camera device is disclosed. The camera device includes a camera system configured to capture image data in a real-time display mode, one or more processors, and a memory configured to store computer-readable instructions that, when executed by the one or more processors, cause the one or more processors to perform operations. The operations include applying a Gaussian pyramid blur to the image data to provide blurred-image data, executing a denoising preprocess on the blurred-image data to provide noise-reduced image data, filtering the noise-reduced image data using a focus-value filter to provide a filtered output, and extracting a focus value from the filtered output to use in a contrast-detection autofocus operation for focusing a lens of the camera system.

This summary is provided to introduce simplified concepts of an image-denoising preprocess for robust contrast-detection autofocus with low-light and low-contrast subjects, which are further described below in the Detailed Description. This summary is not intended to identify essential features of the claimed subject matter.

### BRIEF DESCRIPTION OF THE DRAWINGS

The details of one or more aspects of an image-denoising preprocess for robust contrast-detection autofocus with low-light and low-contrast subjects are described in this document with reference to the following drawings. The same numbers are used throughout the drawings to reference like features and components:

FIG. 1 illustrates an example network environment in which aspects of an image-denoising preprocess for robust contrast-detection autofocus with low-light and low-contrast subjects can be implemented;

FIG. 2 illustrates an example implementation of an electronic device from FIG. 1 in more detail;

FIG. 3 illustrates an example pipeline for an image-denoising preprocess for robust conventional contrast-detection autofocus with low-light and low-contrast subjects, in accordance with one or more implementations;

FIG. 4 depicts an example method for an image-denoising preprocess for robust contrast-detection autofocus with low-light and low-contrast subjects as described herein;

FIG. 5 illustrates an example wireless network device that can be implemented as any of the wireless network devices in a home area network in accordance with one or more aspects of an image-denoising preprocess for robust contrast-detection autofocus with low-light and low-contrast subjects as described herein; and

FIG. 6 illustrates an example system that includes an example device, which can be implemented as any of the wireless network devices that implement aspects of an image-denoising preprocess for robust contrast-detection autofocus with low-light and low-contrast subjects as described with reference to the previous FIGS. 1 to 5.

### DETAILED DESCRIPTION

The present document describes an image-denoising preprocess for robust contrast-detection autofocus with low-light and low-contrast subjects. Generally, conventional contrast-detection autofocus (CDAF) systems perform poorly in low-light and low-texture scenes due to noise in the hardware signal. The techniques described herein provide a software preprocessing approach for denoising image data for contrast-detection autofocus, particularly with low-light conditions and low-contrast subjects. Contrast-detection autofocus is a method of focusing, commonly used in digital cameras, which uses the image sensor itself to determine the correct focus distance. This software autofocus technique may be referred to herein as a “software focus value” (SWFV) and includes utilizing a Gaussian pyramid to break down an image into successively smaller groups of pixels to blur the image. The Gaussian pyramid helps reduce noise and downscales the image to reduce computation costs. In aspects, a spatially adaptive denoise preprocessing technique (e.g., Wiener filter, bilateral filter) is then applied to further reduce noise prior to CDAF measurement generation. The denoise preprocessing technique provides a denoised output signal that is used as input to a focus-value filter for multizone focus-value measurements usable for focusing the camera to enhance the sharpness of the image. The multizone focus-value measurements are a set of focus values that correspond to different zones or areas of the image (e.g., center, upper left, upper right, lower left, lower right, etc.) and that are used to determine an image focus point. The camera can determine which zone to use to determine the image focus point. For example, the camera can perform autofocusing based on a point in one of the zones, such as a zone within which the subject (e.g., a face) is located.

Applying such preprocessing techniques enables generation of more-accurate CDAF measurements and faster autofocus operation of the camera compared to the conventional HW CDAF systems in low-light, low-contrast conditions. In such conditions, conventional HW CDAF systems have long scan times and long back impulse, whereas the disclosed SWFV system has shorter back impulse and is visually much smoother when changing focus onto different areas of the image.

While features and concepts of the described techniques for an image-denoising preprocess for robust contrast-detection autofocus with low-light and low-contrast subjects can be implemented in any number of different environments, aspects are described in the context of the following examples.

### Example Systems and Apparatuses

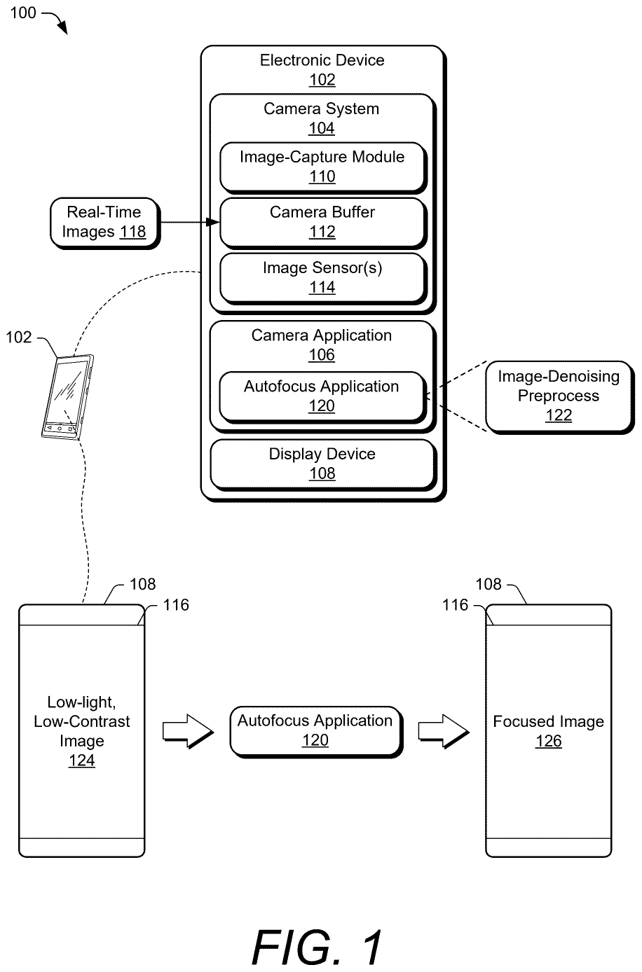

FIG. 1 illustrates an example environment 100 in which aspects of an image-denoising preprocess for robust contrast-detection autofocus with low-light and low-contrast subjects can be implemented. The example environment 100 includes an electronic device 102 (e.g., user device), which includes, or is associated with, a camera system 104, a camera application 106, and a display device 108. As further described below, the camera system 104 can include, among other features, an image-capture module 110, a camera buffer 112, and an image sensor 114.

When the camera system 104 is executing, a user interface 116 may be displayed via the display device 108. The user interface 116 may present real-time images/video representing a view through a viewfinder (e.g., a scene detected within a field of view of the image sensor 114).

The camera application 106 can be implemented or executed to provide access to and operate the camera system 104 (e.g., opening the shutter, capturing images and videos, providing a preview mode representing a view through the viewfinder). The image-capture module 110 can be implemented to record the real-time images/video (e.g., real-time images 118), detected by the image sensor 114 during a real-time display mode (e.g., the preview mode) of the camera system 104, into volatile memory (e.g., the camera buffer 112) of the camera system 104. The camera buffer 112 may include random access memory (RAM), including dynamic RAM or static RAM. The image-capture module 110 can record the real-time images 118 detected by the image sensor at any suitable frame rate, including 4 frames per second (fps), 6 fps, 10 fps, 20 fps, and so forth. Depending on the size of the camera buffer 112, a limited number of frames can be included therein. The image-capture module 110 can continue to overwrite the real-time images 118 recorded in the camera buffer 112, e.g., in a first-in-first-out manner, essentially maintaining images of the last “X” number of seconds in the camera buffer 112 as time progresses. The image-capture module 110 can also be implemented to, in response to a user input that activates a shutter control (virtual or mechanical), capture an image of the scene within the field of view of the image sensor 114 and store the image in non-volatile memory (e.g., read-only memory (ROM), erasable ROM, hard disk drive (HDD), flash memory, optical disc, magnetic tape).

The camera application 106 can include an autofocus application 120 implemented as software and configured to automatically focus the camera system 104. In some aspects, the autofocus application 120 uses an image-denoising preprocess 122 on the real-time images 118 prior to performing contrast-detection autofocus measurements. Such preprocessing reduces high frequency noise and enhances the image data to enable the autofocus application 120 to more-accurately locate peak patterns used for determining and/or calculating a focus value, which is used to adjust a focal length or focus distance of the camera system 104. By using the autofocus application 120, a low-light, low-contrast image 124 can be converted into a focused image 126 faster and more accurately compared to conventional camera systems.

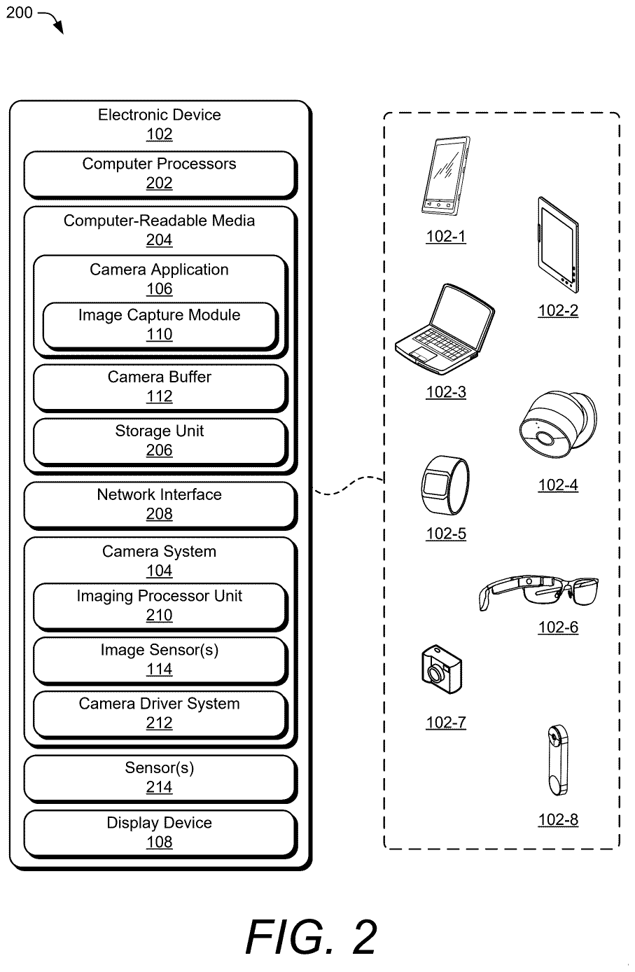

FIG. 2 illustrates an example implementation 200 of the electronic device 102 from FIG. 1 in more detail. The electronic device 102 of FIG. 2 is illustrated with a variety of example devices, including a smartphone 102-1, a tablet 102-2, a laptop 102-3, a desktop computer 102-4, and a computing watch 102-5. The electronic device 102 can also include other devices, such as televisions, entertainment systems, audio systems, gaming systems, automobiles, drones, track pads, drawing pads, netbooks, e-readers, home security systems, and other home appliances. Note that the electronic device 102 can be wearable, non-wearable but mobile, or relatively immobile (e.g., desktops and appliances).

The electronic device 102 also includes one or more computer processors 202 and one or more computer-readable media 204, which includes memory media and storage media. Applications (e.g., the camera application 106) and/or an operating system (not shown) implemented as computer-readable instructions on the computer-readable media 204 can be executed by the computer processors 202 to provide some or all of the functionalities described herein. For example, the computer-readable media 204 can include the image-capture module 110

The computer-readable media 204 also includes non-volatile memory, such as a storage unit 206, in which images that are captured by the image sensor 114 can be stored. The storage unit 206 is configured to store a gallery of images that are captured by the image sensor(s) 114 based on, for example, activation of a shutter control during the real-time display mode.

The electronic device 102 may also include a network interface 208. The electronic device 102 can use the network interface 208 for communicating data over wired, wireless, or optical networks. By way of example and not limitation, the network interface 208 may communicate data over a local-area-network (LAN), a wireless local-area-network (WLAN), a personal-area-network (PAN), a wide-area-network (WAN), an intranet, the Internet, a peer-to-peer network, point-to-point network, or a mesh network.

Various implementations of the camera system 104 can include a System-on-Chip (SoC), one or more Integrated Circuits (ICs), a processor with embedded processor instructions or configured to access processor instructions stored in memory, hardware with embedded firmware, a printed circuit board with various hardware components, or any combination thereof.

The camera system 104 includes an imaging processor unit 210, the one or more image sensors 114, and a camera driver system 212. The camera driver system 212 enables communication between the camera system 104 and other components of the electronic device 102, such as the computer processors 202 and the image-capture module 110. The camera driver system 212 can be initiated by any suitable trigger, such as a user input received via an actuated control or pressed button, or a signal received from one or more sensors 214.

The one or more sensors 214 of the electronic device 102 can include any of a variety of sensors, such as an audio sensor (e.g., a microphone), a touch-input sensor (e.g., a touchscreen), an image-capture device (e.g., a camera or video-camera), proximity sensors (e.g., capacitive sensors), an ambient light sensor (e.g., photodetector), or a haptic sensor (e.g., piezoelectric actuators, eccentric rotating mass (ERM) actuators, linear resonant actuators (LRA)).

The electronic device 102 can also include a display device, such as the display device 108. The display device 108 can include any suitable display device, such as a touchscreen, a liquid crystal display (LCD), thin film transistor (TFT) LCD, an in-place switching (IPS) LCD, a capacitive touchscreen display, an organic light-emitting diode (OLED) display, an active-matrix organic light-emitting diode (AMOLED) display, super AMOLED display, and so forth.

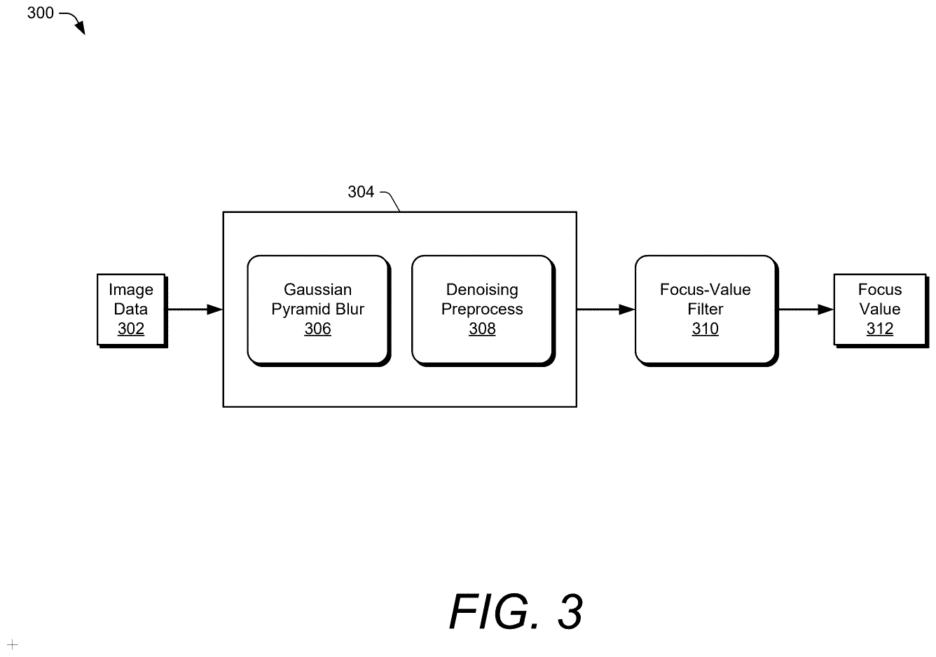

These and other capabilities and configurations, as well as ways in which entities of FIGS. 1 and 2 act and interact, are set forth in greater detail below. These entities may be further divided, combined, and so on. The network environment 100 of FIG. 1 and the detailed illustrations of FIG. 2 through FIG. 6 illustrate some of many possible environments, devices, and methods capable of employing the described techniques, whether individually or in combination with one another. FIGS. 3 to 6 illustrate various implementations of an image-denoising preprocess for robust contrast-detection autofocus with low-light and low-contrast subjects and are not necessarily limited to the combinations shown for implementing the described techniques. These implementations may be further divided, combined, reorganized, or linked to provide a wide array of additional and/or alternate implementations.

FIG. 3 illustrates an example pipeline 300 for an image-denoising preprocess (e.g., the image-denoising preprocess 122) for robust conventional contrast-detection autofocus with low-light and low-contrast subjects, in accordance with one or more implementations. Image data 302 (e.g., real-time image(s) 118) captured by an image sensor of a camera module (e.g., the image sensor(s) 114 of the camera system 104) is input into a software preprocessing block 304 of the pipeline 300. In the software preprocessing block 304, a Gaussian pyramid blur is applied to the image data 302. A Gaussian pyramid is an image processing technique that breaks down an image into successively smaller groups of pixels to blur the image. In one example Gaussian pyramid, subsequent images (e.g., scaled down copies of the image) are weighted down using a Gaussian average and scaled down. Each pixel containing a local average corresponds to a neighborhood pixel on a lower level of the pyramid. In the example pipeline 300, the Gaussian pyramid is used to blur the image data 302 and provide a blurred image (e.g., blurred image data) as output. Any suitable type of Gaussian pyramid can be implemented, including, for example, a lowpass pyramid or a bandpass pyramid.

Accordingly, the Gaussian pyramid is created using a set of versions of the same image with different resolutions. These images in the set are stacked with the highest resolution at the bottom and the lowest resolution at the top. A higher-level image (e.g., lower resolution) of the pyramid is formed by downsampling (e.g., reducing the number of pixels by a defined amount, such as 25%). Each pixel in the higher level can be formed based on a weighted average (e.g., Gaussian weight(s)) of its corresponding pixel in the underlying level together with the 4 orthogonally adjacent pixels in that underlying level. By doing so, an M×N image becomes an M/2×N/2 image. As such, the corresponding area is reduced to one-fourth the original area. This pattern of area reduction is repeated for each subsequent higher level of the pyramid.

A denoising preprocess 308 can also be applied to the image data, in particular to the output of the Gaussian pyramid blur (e.g., the blurred image). The denoising preprocess 308 can include a smoothing filter that removes high frequency noise while preserving strong edges. The denoising preprocess 308 can include any suitable filter, including a bilateral filter or a Wiener filter.

A bilateral filter is a non-linear smoothing filter that replaces the intensity of each pixel with a weighted average of intensity values from neighboring (e.g., spatially adjacent) pixels. Accordingly, for the bilateral filter, two pixels are “close” to each other not only if they occupy nearby spatial locations but also if they have some similarity in the photometric range (e.g., similar intensities). The bilateral filter is generally controlled by two parameters, a spatial parameter and a range parameter. Increasing the spatial parameter smooths larger features in the image. Increasing the range parameter causes the bilateral filter to become closer to the Gaussian blur because the Gaussian range is almost constant over the intensity interval covered by the image. In an example, a bilateral filter (e.g., 5×5 bilateral filter, a 7×7 bilateral filter, a 9×9 bilateral filter, etc.) is implemented. In aspects, the weighted average used by the bilateral filter is based on a Gaussian distribution. To preserve sharp edges, the weights can depend not only on the Euclidean distance of pixels but also on the radiometric differences (e.g., range differences such as color intensity, depth distance, etc.).

A Wiener filter is a linear time-invariant (LTI) smoothing filter. The Wiener filter removes additive noise and inverts blurring simultaneously. A Wiener filtering process is a linear estimation of the original image. In particular, the Wiener filter minimizes the overall mean square error in the process of inverse filtering and noise smoothing. The Wiener filter performs deconvolution by inverse filtering (highpass filtering) and also removes noise with a compression operation (lowpass filtering). In one example, a spatially adaptive 5×5 Wiener filter kernel is implemented that uses a frame adaptive noise standard deviation estimate.

In implementations, the Gaussian pyramid is first applied to help reduce noise and downscale the image data to reduce computation costs. Then, the denoising preprocess 308 is applied to further reduce noise, prior to generation of CDAF measurements. CDAF is achieved by analyzing pixels on the camera's image sensor and measuring contrast (e.g., intensity difference) between adjacent pixels of the image sensor. The intensity difference between adjacent pixels increases with correct image focus. By adjusting the focus back and forth, the camera can calculate the highest points of contrast within an image frame to determine the correct or optimal focus for the image.

The software processing block 304 provides an output, such as a noise-reduced image, which is then used by a focus-value filter 310 to extract a focus value 312 (e.g., measurement). The focus-value filter 310 includes any suitable filter, such as a bandpass filter, a Sobel filter, an infinite impulse response (IIR) filter, a finite impulse response (FIR) filter, etc. The camera system 104 uses the focus value 312 for a CDAF search. For example, the focus value 312 represents an estimation of image contrast or the degree of focus of the image. Using the focus value 312, the camera system 104 can adjust a focus distance and/or a focal length of the lens of the camera. The focal length is the distance from a focusing plane (e.g., location of the camera's image sensor) to an optical center of the lens. The focus distance is the distance from the focusing plane to the subject.

### Example Methods

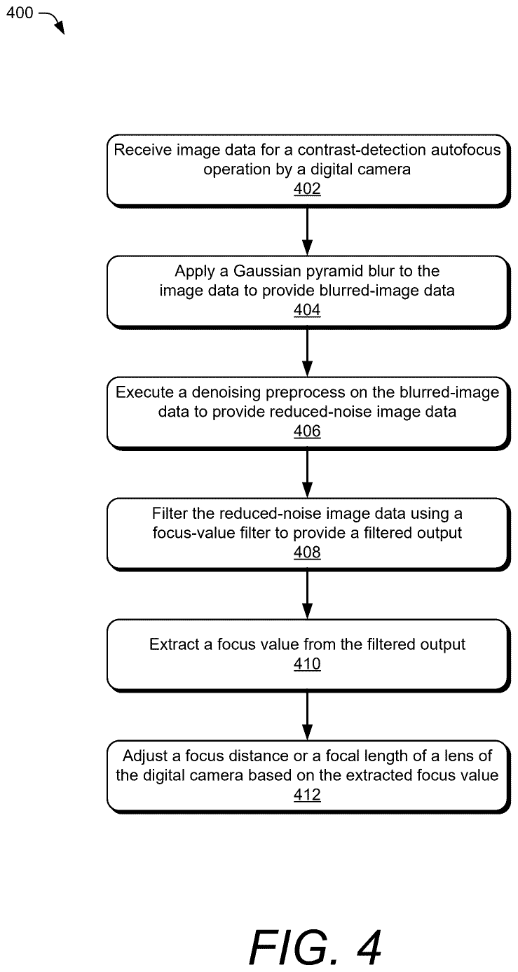

FIG. 4 depicts an example method 400 for an image-denoising preprocess for robust contrast-detection autofocus with low-light and low-contrast subjects as described herein. The method 400 can be performed by the electronic device 102 to implement the described techniques, in particular by using the camera application 106 and/or the autofocus application 120. The method 400 is shown as a set of blocks that specify operations performed but are not necessarily limited to the order or combinations shown for performing the operations by the respective blocks. Further, any of one or more of the operations may be repeated, combined, reorganized, or linked to provide a wide array of additional and/or alternate methods. In portions of the following discussion, reference may be made to the example network environment 100 of FIG. 1 or to entities or processes as detailed in FIGS. 2 and 3, reference to which is made for example only. The techniques are not limited to performance by one entity or multiple entities operating on one device.

At 402, image data is received by a digital camera for a contrast-detection autofocus operation. For example, the camera system 104 receives the image data 302 based on the image sensor 114 of the camera system 104 capturing the image data 302 in a live-preview mode. The live-preview mode is a camera mode in which the camera system 104 captures a stream of image data (e.g., video) and displays the stream of image data in real time on the display 220. Generally, the stream of image data is temporarily stored in a buffer, such as a First-In, First-Out (FIFO) buffer. In aspects, the image data is generated in low-light conditions with a low-contrast subject. Due to such conditions, the image data has low contrast, which is difficult for conventional hardware CDAF systems.

At 404, a Gaussian pyramid blur is applied to the image data to provide blurred-image data. For example, the processor(s) 202 breaks the pixels of the image data down into successively smaller groups of pixels. Each successively smaller group forms a different layer of the Gaussian pyramid. As mentioned, the pyramid is constructed by repeatedly calculating a weighted average of the neighboring pixels of a source image and scaling the image down to blur the image. The pyramid can be visualized by stacking progressively smaller versions of the image on top of one another. This process creates a pyramid shape with the base as the original image and the tip of the pyramid being a single pixel representing the average value of the entire image.

At 406, a denoising preprocess is executed on the blurred image data to provide a noise-reduced image. The denoising preprocess takes the Gaussian pyramid layers as input and removes high frequency noise while keeping strong edges. The denoising preprocess can be any suitable filter, such as a Wiener filter, a bilateral filter, and so on. The denoising preprocess enhances peak patterns in the image data, particularly after the Gaussian pyramid blur has been applied.

At 408, the noise-reduced image is filtered using a focus-value filter to provide a filtered output. For example, the output of the software processing block 304 (output of the Gaussian pyramid blur 306 and/or the output of the denoising preprocess) is filtered by the focus-value filter 310. The focus-value filter is used to perform a CDAF search to locate a correct peak pattern and peak position in the image data.

At 410, a focus value is extracted from the filtered output. For example, the processor 216 or the imaging processor unit 210 extracts the focus value 312 from the filtered output. In an example, the focus value 312 is identified or computed based on the identified peak pattern and position.

At 412, a focus distance or a focal length of a lens of the digital camera is adjusted based on the extracted focus value. For example, the processor 216 or the imaging processor unit 210 uses the focus value 312 extracted from the filtered output to automatically adjust the focal length and/or the focus distance of the lens of the camera system 104. Such an adjustment focuses the image.

### Example Environments and Devices

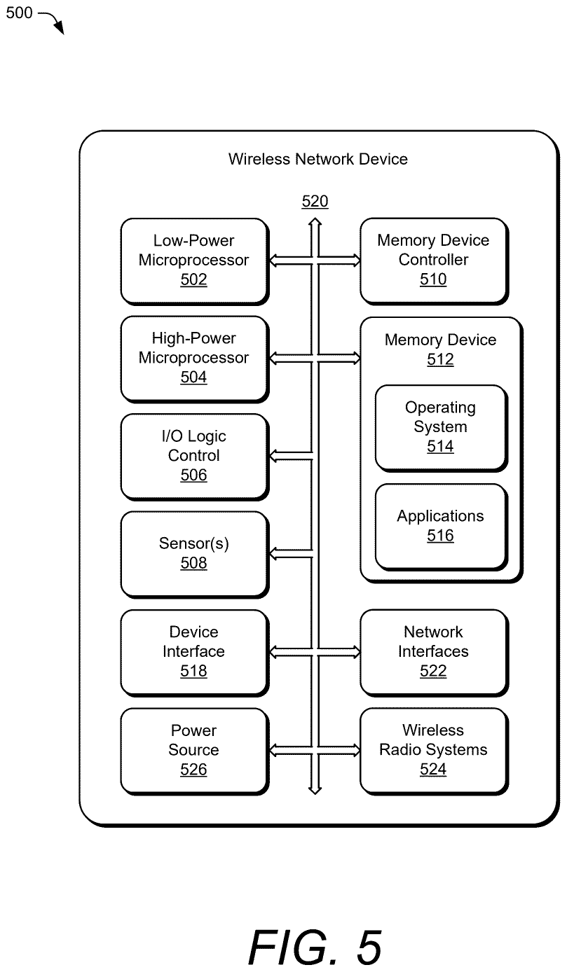

FIG. 5 illustrates an example wireless network device 500 that can be implemented as any electronic camera device (e.g., the electronic device 102) in accordance with one or more aspects of an image-denoising preprocess for robust contrast-detection autofocus with low-light and low-contrast subjects as described herein. The device 500 can be integrated with electronic circuitry, microprocessors, memory, input/output (I/O) logic control, communication interfaces and components, as well as other hardware, firmware, and/or software to implement the device. Further, the wireless network device 500 can be implemented with various components, such as with any number and combination of different components as further described with reference to the example device 500 shown in FIG. 5.

In this example, the wireless network device 500 includes a low-power microprocessor 502 and a high-power microprocessor 504 (e.g., microcontrollers or digital signal processors) that process executable instructions. The device 500 also includes an input-output (I/O) logic control 506 (e.g., to include electronic circuitry). The microprocessors 502 and 504 can include components of an IC, a programmable logic device, a logic device formed using one or more semiconductors, and other implementations in silicon and/or hardware, such as a processor and memory system implemented as an SoC. Alternatively or in addition, the device can be implemented with any one or combination of software, hardware, firmware, or fixed logic circuitry that may be implemented with processing and control circuits. The low-power microprocessor 502 and the high-power microprocessor 504 can also support one or more different device functionalities of the device. For example, the high-power microprocessor 504 may execute computationally intensive operations, whereas the low-power microprocessor 502 may manage less complex processes such as detecting a hazard or temperature from one or more sensors 508. The low-power microprocessor 502 may also wake or initialize the high-power microprocessor 504 for computationally intensive processes.

The one or more sensors 508 can be implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio frequency (RF), other electromagnetic signals or fields, or the like. As such, the sensors 508 may include any one or a combination of temperature sensors, humidity sensors, hazard-related sensors, other environmental sensors, accelerometers, microphones, optical sensors up to and including cameras (e.g., charged coupled-device or video cameras), active or passive radiation sensors, GPS receivers, and RF identification detectors. In implementations, the wireless network device 500 may include one or more primary sensors, as well as one or more secondary sensors, such as primary sensors that sense data central to a core operation of the device (e.g., sensing a temperature in a thermostat or sensing smoke in a smoke detector) and secondary sensors that may sense other types of data (e.g., motion, light, or sound), which can be used for energy-efficiency objectives or automation objectives.

The wireless network device 500 includes a memory device controller 510 and a memory device 512, such as any type of a nonvolatile memory and/or another suitable electronic data storage device. The wireless network device 500 can also include various firmware and/or software, such as an operating system 514 that is maintained as computer-executable instructions by the memory device 512 and executed by a microprocessor. The device software may also include one or more applications 516 that implement various functionalities of the wireless network device 500. The wireless network device 500 also includes a device interface 518 to interface with another device or peripheral component and includes an integrated data bus 520 that couples the various components of the wireless network device 500 for data communication between the components. The data bus 520 in the wireless network device 500 may also be implemented as any one or a combination of different bus structures and/or bus architectures.

The device interface 518 may receive input from a user and/or provide information to the user (e.g., as a user interface), and a received input can be used to determine a setting. The device interface 518 may also include mechanical or virtual components that respond to a user input. For example, the user can mechanically move a sliding or rotatable component, or a motion along a touchpad may be detected, and such motions may correspond to a setting adjustment of the device 500. Physical and virtual movable user-interface components can allow the user to set a setting along a portion of an apparent continuum. The device interface 518 may also receive inputs from any number of peripherals, such as buttons, a keypad, a switch, a microphone, and an imager (e.g., a camera device).

The wireless network device 500 can include network interfaces 522 (e.g., network interface 208), such as a network interface for communication with other wireless network devices, and an external network interface for network communication, such as via the Internet. The wireless network device 500 also includes wireless radio systems 524 for wireless communication with other wireless network devices via the network interface and for multiple, different wireless communications systems. The wireless radio systems 524 may include Wi-Fi, Bluetooth™, Mobile Broadband, Bluetooth Low Energy (BLE), and/or point-to-point IEEE 802.15.4. Each of the different radio systems can include a radio device, antenna, and chipset that is implemented for a particular wireless communications technology. The wireless network device 500 also includes a power source 526, such as a battery and/or a cable to connect the device 500 to line voltage. An alternating current (AC) power source may also be used to charge the battery of the device.

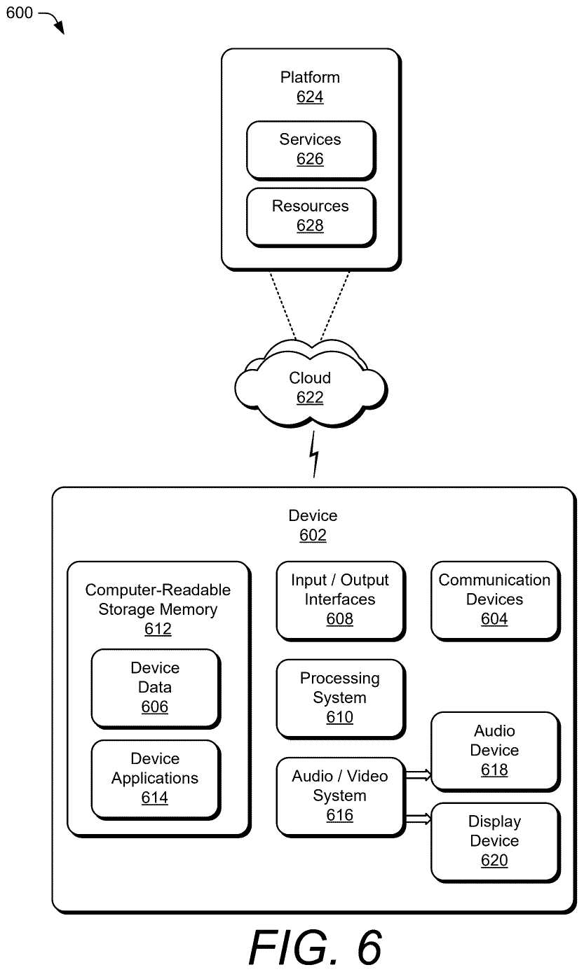

FIG. 6 illustrates an example system 600 that includes an example device 602, which can be implemented as any electronic camera device (e.g., the electronic device 102) that implements aspects of an image-denoising preprocess for robust contrast-detection autofocus with low-light and low-contrast subjects as described with reference to the previous FIGS. 1 to 5. The example device 602 may be any type of computing device, client device, mobile phone, tablet, communication, entertainment, gaming, media playback, and/or other type of device. Further, the example device 602 may be implemented as any other type of wireless network device that is configured for communication on a network, such as a thermostat, hazard detector, camera, lighting unit, commissioning device, router, border router, joiner router, joining device, end device, leader, or access point, and/or other wireless network devices.

The device 602 includes communication devices 604 that enable wired and/or wireless communication of device data 606, such as data that is communicated between devices in a network, data that is being received, data scheduled for broadcast, data packets of the data, data that is synchronized between the communication devices 604, etc. The device data 606 can include any type of communication data, as well as audio, video, and/or image data that is generated by applications executing on the device 602. The communication devices 604 can also include transceivers for cellular phone communication and/or for network data communication.

The device 602 also includes input/output (I/O) interfaces 608, such as data network interfaces (e.g., network interface 208) that provide connection and/or communication links between the device 602, data networks (e.g., a HAN, external network, etc.), and other devices. The I/O interfaces 608 can be used to couple the device 602 to any type of components, peripherals, and/or accessory devices. The I/O interfaces 608 also include data input ports via which any type of data, media content, and/or inputs can be received, such as user inputs to the device 602, as well as any type of communication data, as well as audio, video, and/or image data received from any content and/or data source.

The device 602 includes a processing system 610 (e.g., processors 202) that may be implemented at least partially in hardware, such as with any type of microprocessors, controllers, and the like that process executable instructions. The processing system can include components of an IC, a programmable logic device, a logic device formed using one or more semiconductors, and other implementations in silicon and/or hardware, such as a processor and memory system implemented as an SoC. Alternatively or in addition, the device 602 can be implemented with any one or combination of software, hardware, firmware, or fixed logic circuitry that may be implemented with processing and control circuits. The device 602 may further include any type of a system bus or other data and command transfer system that couples the various components within the device 602. A system bus can include any one or combination of different bus structures and architectures, as well as control and data lines.

The device 602 also includes computer-readable storage memory 612 (e.g., CRM 204), such as data storage devices that can be accessed by a computing device and that provide persistent storage of data and executable instructions (e.g., software applications, modules, programs, functions, and the like). The computer-readable storage memory 612 described herein excludes propagating signals. Examples of computer-readable storage memory include volatile memory and non-volatile memory, fixed and removable media devices, and any suitable memory device or electronic data storage that maintains data for computing device access. The computer-readable storage memory 612 can include various implementations of random access memory (RAM), read-only memory (ROM), flash memory, erasable programmable read-only memory (EPROM), electrically erasable programmable read-only memory (EEPROM), and other types of storage memory in various memory device configurations.

The computer-readable storage memory 612 provides storage of the device data 606 and various device applications 614, such as an operating system that is maintained as a software application with the computer-readable storage memory 612 and executed by the processing system 610. The device applications 614 may also include a device manager, such as any form of a control application, a software application, a signal processing and control module, code that is native to a particular device, a hardware abstraction layer for a particular device, and so on.

The device 602 also includes an audio and/or video system 616 that generates audio data for an audio device 618 and/or generates display data for a display device 620 (e.g., the display device 108). The audio device 618 and/or the display device 620 include any devices that process, display, and/or otherwise render audio, video, display, and/or image data, such as image content of a digital photo. In implementations, the audio device 618 and/or the display device 620 are integrated components of the example device 602. Alternatively, the audio device 618 and/or the display device 620 are external, peripheral components to the example device 602. In aspects, at least part of the techniques described for an image-denoising preprocess for robust contrast-detection autofocus with low-light and low-contrast subjects may be implemented in a distributed system, such as over a “cloud” 622 in a platform 624. The cloud 622 includes and/or is representative of the platform 624 for services 626 and/or resources 628.

The platform 624 abstracts underlying functionality of hardware, such as server devices (e.g., included in the services 626) and/or software resources (e.g., included as the resources 628), and connects the example device 602 with other devices, servers, etc. The resources 628 may also include applications and/or data that can be utilized while computer processing is executed on servers that are remote from the example device 602. Additionally, the services 626 and/or the resources 628 may facilitate subscriber network services, such as over the Internet, a cellular network, or a Wi-Fi network. The platform 624 may also serve to abstract and scale resources to service a demand for the resources 628 that are implemented via the platform 624, such as in an interconnected device aspect with functionality distributed throughout the system 600. For example, the functionality may be implemented in part at the example device 602 as well as via the platform 624 that abstracts functionality of the cloud 622.

Some examples are described below:

Example 1: A method for an image-denoising preprocess for robust contrast-detection autofocus with low-light conditions and low-contrast subjects, the method comprising: receiving image data for a contrast-detection autofocus operation by a digital camera; applying a Gaussian pyramid blur to the image data to provide blurred-image data; executing a denoising preprocess on the blurred-image data to provide noise-reduced image data; filtering the noise-reduced image data using a focus-value filter to provide a filtered output; and extracting a focus value from the filtered output to use in the contrast-detection autofocus operation for focusing the digital camera.

Example 2: The method of claim 1, wherein the image data includes at least one real-time image captured by the digital camera in a real-time display mode.

Example 3: The method of claim 1 or claim 2, wherein applying the Gaussian pyramid blur includes breaking down the image data into successively smaller groups of pixels to blur the image data.

Example 4: The method of any one of claims 1 to 3, wherein the blurred-image data includes a plurality of Gaussian pyramid layers.

Example 5: The method of any one of claims 1 to 4, wherein the Gaussian pyramid blur includes a lowpass pyramid or a bandpass pyramid.

Example 6: The method of any one of claims 1 to 5, further comprising adjusting a focus distance or a focal length of a lens of the digital camera based on the focus value extracted from the filtered output.

Example 7: The method of any one of claims 1 to 6, wherein the focus-value filter includes at least one of a bandpass filter, a Sobel filter, an infinite impulse response filter, or a finite impulse response filter.

Example 8: The method of any one of claims 1 to 7, wherein: filtering the noise-reduced image data using the focus-value filter includes identifying a peak pattern in the filtered output, and extracting the focus value includes extracting the focus value from the filtered output based on the identified peak pattern in the filtered output.

Example 9: The method of any one of claims 1 to 8, wherein executing the denoising preprocess includes applying a Wiener filter to remove high frequency noise and maintain edges.

Example 10: The method of any one of claims 1 to 8, wherein executing the denoising preprocess includes applying a bilateral filter to remove high frequency noise and maintain edges.

Example 11: The method of claim 10, wherein the bilateral filter includes a 5×5 bilateral filter, a 7×7 bilateral filter, or a 9×9 bilateral filter.

Example 12: The method of any one of claims 1 to 11, wherein the filtered output comprises a plurality of multizone focus-value measurements.

Example 13: An electronic device comprising: a camera system configured to capture image data in a real-time display mode; one or more processors; and a memory configured to store computer-readable instructions that, when executed by the one or more processors, cause the one or more processors to perform operations comprising: applying a Gaussian pyramid blur to the image data to provide blurred-image data; executing a denoising preprocess on the blurred-image data to provide noise-reduced image data; filtering the noise-reduced image data using a focus-value filter to provide a filtered output; and extracting a focus value from the filtered output to use in a contrast-detection autofocus operation for focusing a lens of the camera system.

1. A method for an image-denoising preprocess for robust contrast-detection autofocus with low-light conditions and low-contrast subjects, the method comprising:
receiving image data for a contrast-detection autofocus operation by a digital camera;
applying a Gaussian pyramid blur to the image data to provide blurred-image data;
executing a denoising preprocess on the blurred-image data to provide noise-reduced image data;
filtering the noise-reduced image data using a focus-value filter to provide a filtered output; and
extracting a focus value from the filtered output to use in the contrast-detection autofocus operation for focusing the digital camera.

2. The method of claim 1, wherein the image data includes at least one real-time image captured by the digital camera in a real-time display mode.

3. The method of claim 1, wherein applying the Gaussian pyramid blur includes breaking down the image data into successively smaller groups of pixels to blur the image data.

4. The method of claim 1, wherein the blurred-image data includes a plurality of Gaussian pyramid layers.

5. The method of claim 1, wherein the Gaussian pyramid blur includes a lowpass pyramid or a bandpass pyramid.

6. The method of claim 1, further comprising adjusting a focus distance or a focal length of a lens of the digital camera based on the focus value extracted from the filtered output.

7. The method of claim 1, wherein the focus-value filter includes at least one of a bandpass filter, a Sobel filter, an infinite impulse response filter, or a finite impulse response filter.

8. The method of claim 1, wherein:
filtering the noise-reduced image data using the focus-value filter includes identifying a peak pattern in the filtered output, and
extracting the focus value includes extracting the focus value from the filtered output based on the identified peak pattern in the filtered output.

9. The method of claim 1, wherein executing the denoising preprocess includes applying a Wiener filter to remove high frequency noise and maintain edges.

10. The method of claim 1, wherein executing the denoising preprocess includes applying a bilateral filter to remove high frequency noise and maintain edges.

11. The method of claim 10, wherein the bilateral filter includes a 5×5 bilateral filter, a 7×7 bilateral filter, or a 9×9 bilateral filter.

12. The method of claim 1 wherein the filtered output comprises a plurality of multizone focus-value measurements.

13. An electronic device comprising:
a camera system configured to capture image data in a real-time display mode;
one or more processors; and
a memory configured to store computer-readable instructions that, when executed by the one or more processors, cause the one or more processors to perform operations comprising:
applying a Gaussian pyramid blur to the image data to provide blurred-image data;
executing a denoising preprocess on the blurred-image data to provide noise-reduced image data;
filtering the noise-reduced image data using a focus-value filter to provide a filtered output; and
extracting a focus value from the filtered output to use in a contrast-detection autofocus operation for focusing a lens of the camera system.

14. The electronic device of claim 13, wherein:
the camera includes a lens having a focus distance and a focal length; and
the operations further comprise adjusting the focus distance or the focal length based on the focus value extracted from the filtered output.

15. The electronic device of claim 13, wherein:
the blurred-image data includes a plurality of Gaussian pyramid layers; and
executing a denoising preprocess on the blurred-image data includes applying a bilateral filter or a Wiener filter to the plurality of Gaussian pyramid layers.

16. The electronic device of claim 13, wherein:
filtering the noise-reduced image data using the focus-value filter includes identifying a peak pattern in the filtered output, and
extracting the focus value includes extracting the focus value from the filtered output based on the identified peak pattern in the filtered output.

17. The electronic device of claim 13, wherein the Gaussian pyramid blur includes a lowpass pyramid or a bandpass pyramid.

18. One or more computer-readable storage media storing instructions that, when executed by one or more processors of an electronic device, cause the one or more processors to perform operations comprising:
receiving image data for a contrast-detection autofocus operation by a digital camera;
applying a Gaussian pyramid blur to the image data to provide blurred-image data;
executing a denoising preprocess on the blurred-image data to provide noise-reduced image data;
filtering the noise-reduced image data using a focus-value filter to provide a filtered output; and
extracting a focus value from the filtered output to use in the contrast-detection autofocus operation for focusing the digital camera.

19. The one or more computer-readable media of claim 18, wherein:
filtering the noise-reduced image data using the focus-value filter includes identifying a peak pattern in the filtered output, and
extracting the focus value includes extracting the focus value from the filtered output based on the identified peak pattern in the filtered output.

20. The one or more computer-readable media of claim 18, wherein:
the blurred-image data includes a plurality of Gaussian pyramid layers; and
executing a denoising preprocess on the blurred-image data includes applying a bilateral filter or a Wiener filter to the plurality of Gaussian pyramid layers.
